(19) United States
(12) Patent Application Publication
(10) Pub. No.: US 2025/0017127 A1
(43) Pub. Date: Jan. 16, 2025

(54) REAR FOLDING AGRICULTURAL IMPLEMENT AND RELATED SYSTEMS AND METHODS

(71) Applicant: CNH Industrial America LLC, New Holland, PA (US)

(72) Inventors: Brian Michael Craig, Congerville, IL (US); William E. Preller, Congerville, IL (US); Michael J. Grossen, Peoria, IL (US); Timothy Crumrine, East Peoria, IL (US); Andrew T. Maki, East Peoria, IL (US); Austin Joseph Lewandowski, Congerville, IL (US); Jeffry Scott Huber, Eureka, IL (US)

(21) Appl. No.: 18/769,651

(22) Filed: Jul. 11, 2024

Related U.S. Application Data
(60) Provisional application No. 63/513,133, filed on Jul. 12, 2023.

(51) Int. Cl. A01B 73/06

(52) U.S. Cl. CPC A01B 73/067

(57) ABSTRACT

In one aspect, a rear folding agricultural implement allows for first and second wing sections of a toolbar assembly to be folded relative to a central toolbar section of the toolbar assembly via independently actuatable wing roll sections coupled between the central toolbar section and the respective wing sections.

### CROSS-REFERENCE TO RELATED APPLICATIONS

The present application is based upon and claims the right of priority to U.S. Provisional Patent Application No. 63/513,133, filed Jul. 12, 2023, the disclosure of which is hereby incorporated by reference herein in its entirety for all purposes.

### FIELD OF THE INVENTION

The present subject matter relates generally to agricultural implements, such as strip tillage implements and, more particularly, to a rear folding agricultural implement and related systems and methods.

### BACKGROUND OF THE INVENTION

Rear folding agricultural implements are generally known in the art. However, conventional rear folding systems often encounter numerous issues during folding and can lead to performance issues during operation. Moreover, for implements that include row units, particularly strip tillage implements, there are no viable rear folding configurations available in the market.

Accordingly, an improved rear folding agricultural implement and related systems and methods would be welcomed in the technology.

### BRIEF DESCRIPTION OF THE INVENTION

Aspects and advantages of the invention will be set forth in part in the following description, or may be obvious from the description, or may be learned through practice of the invention.

In one aspect, the present subject matter is directed to a rear-folding agricultural implement that includes a chassis assembly and a toolbar assembly coupled to the chassis assembly. The toolbar assembly trails the chassis assembly in a fore-aft direction of the implement when the implement is moved in a forward travel direction. The toolbar assembly includes a central toolbar section configured to support one or more row units for performing a ground-engaging operation when the implement is in a working position relative to the ground. The toolbar assembly also includes first and second wing roll sections pivotably coupled to the central toolbar section and configured to be positioned rearward of the central toolbar section in the fore-aft direction when the implement is in the working position, with the first wing roll section being pivotably relative to the central toolbar section independently from the second wing roll section. Additionally, the toolbar assembly includes a first wing toolbar section pivotably coupled to the first wing roll section and extending outwardly from the first ring roll section in a lateral direction of the implement when the implement is in the working position. The first wing toolbar section is configured to support a first plurality of row units for performing the ground-engaging operation when the implement is in a working position relative to the ground. Moreover, the toolbar assembly includes a second wing toolbar section pivotably coupled to the second wing roll section and extending outwardly from the second ring roll section in a lateral direction of the implement when the implement is in the working position. The second wing toolbar section being configured to support a second plurality of row units for performing the ground-engaging operation when the implement is in a working position relative to the ground.

In another aspect, the present subject matter is directed to an agricultural implement configured in accordance with one or more embodiments described herein.

In further aspect, the present subject matter is directed to a system for folding an agricultural implement in accordance with one or more embodiments described herein.

In yet another aspect, the present subject matter is directed to a method for folding an agricultural implement in accordance with one or more embodiments described herein.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures, in which:

FIG. 1 illustrates a perspective view of one embodiment of a rear folding agricultural implement in accordance with aspects of the present subject matter;

FIG. 2 illustrates a rear perspective view of the implement shown in FIG. 1 with a storage tank and row units of the implement removed for purposes of illustration;

FIG. 3 illustrates a zoomed-in, perspective view of a central portion of a toolbar assembly of the implement shown in FIG. 2;

FIG. 4 illustrates a zoomed-in perspective view of a more outboard portion of the toolbar assembly of the implement shown in FIG. 2;

FIG. 5 illustrates a front perspective view of the implement shown in FIG. 1 with the storage tank and row units of the implement 100 removed for purposes of illustration;

FIG. 6 illustrates a zoomed-in view of the central portion of the toolbar assembly of the implement shown in FIG. 5;

FIG. 7 illustrates a bottom perspective view of the central portion of the toolbar assembly shown in FIG. 6;

FIG. 8 illustrates a side view of an aft portion of the implement shown in FIGS. 2 and 5;

FIG. 9 illustrates another perspective view of the implement shown in FIG. 2, particularly illustrating the implement after it has transitioned from the working position shown in FIG. 2 to the headland position shown in FIG. 9;

FIG. 10 illustrates a side view of the implement shown in FIG. 9, particularly illustrating the toolbar assembly of the implement at the headland position;

FIG. 11 illustrates another perspective view of the implement shown in FIG. 9, particularly illustrating the implement after it has transitioned from the headland position shown in FIG. 9 to the lift/fold transition position shown in FIG. 11;

FIG. 12 illustrates a side view of the implement shown in FIG. 10, particularly illustrating the toolbar assembly of the implement at the lift/fold transition position;

FIG. 13 illustrates another perspective view of the implement shown in FIG. 12 after the toolbar assembly of the implement has transitioned from the lift/fold transition position shown in FIG. 11 to the rearwardly folded position shown in FIG. 13, with the row units of the implement being shown for purposes of illustration;

FIG. 14 illustrates another perspective view of the implement shown in FIG. 13 after the toolbar assembly of the implement has transitioned from the rearwardly folded position shown in FIG. 13 to the transport position shown in FIG. 14;

FIG. 15 illustrates a top view of the implement shown in FIG. 14 as the implement is executing a narrow turn while in the transport position;

FIG. 16 illustrates a side view of the implement shown in FIG. 14 while one of the wing toolbar sections of the toolbar assembly is raised relative to the other wing toolbar section of the toolbar assembly;

FIG. 17 illustrates a perspective view of a central portion of the toolbar assembly of the implement shown in FIG. 16, particularly illustrating the independent movement of wing roll sections of the toolbar assembly due to the vertically offset nature of the wing toolbar sections; and

FIG. 18 illustrates a perspective, zoomed-in view of a portion of one of the wing toolbar sections when the implement is in the transport position, particularly illustrating a wheel stop assembly for the wing support wheel of the wing toolbar section.

### DETAILED DESCRIPTION OF THE INVENTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

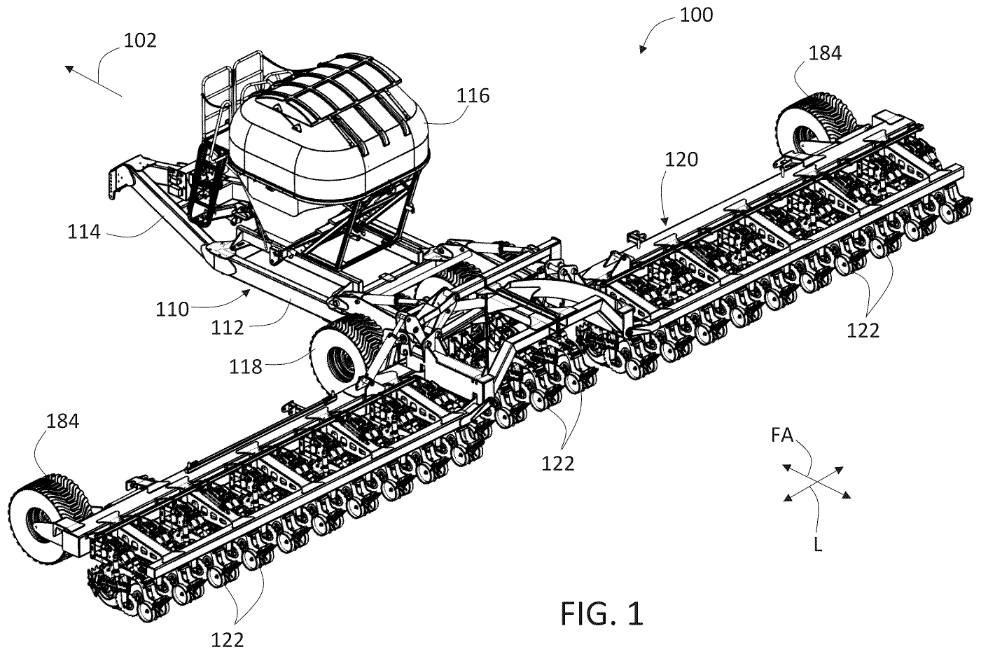

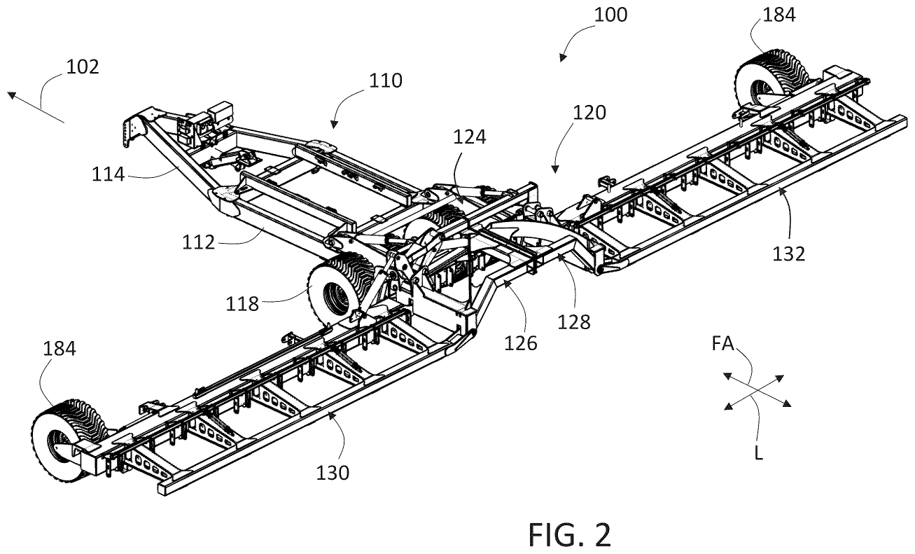

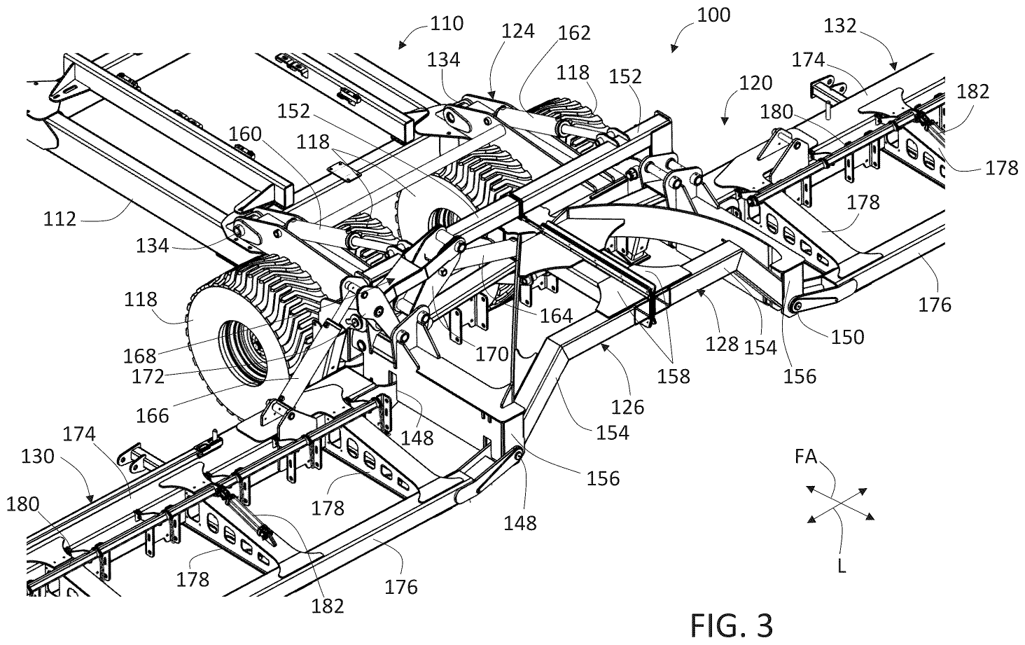

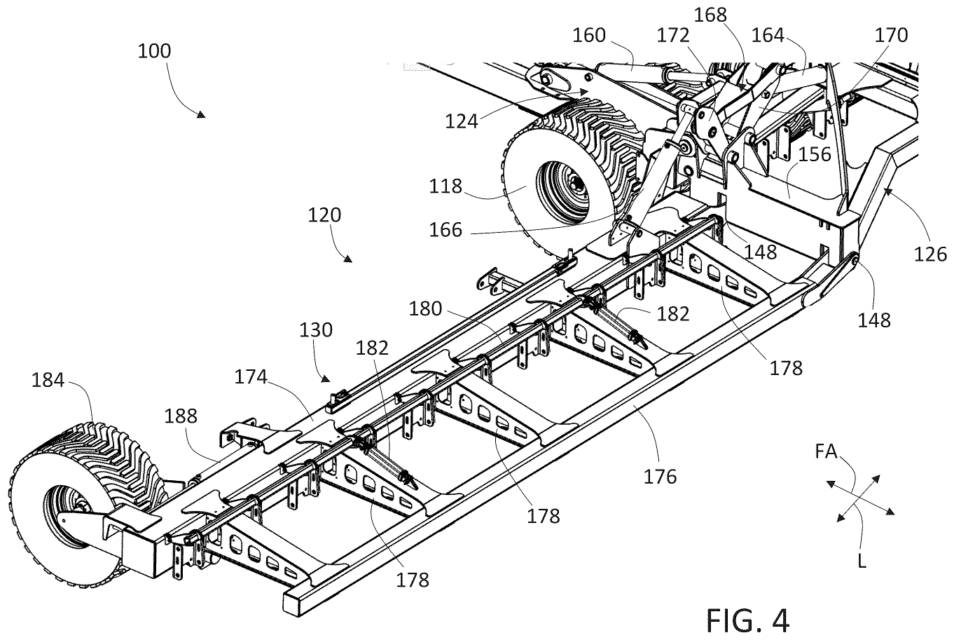

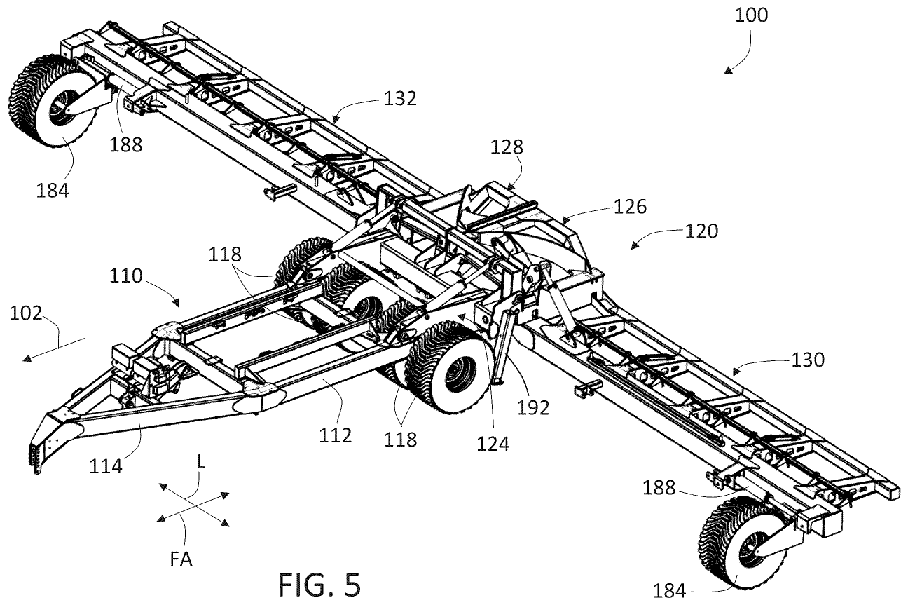

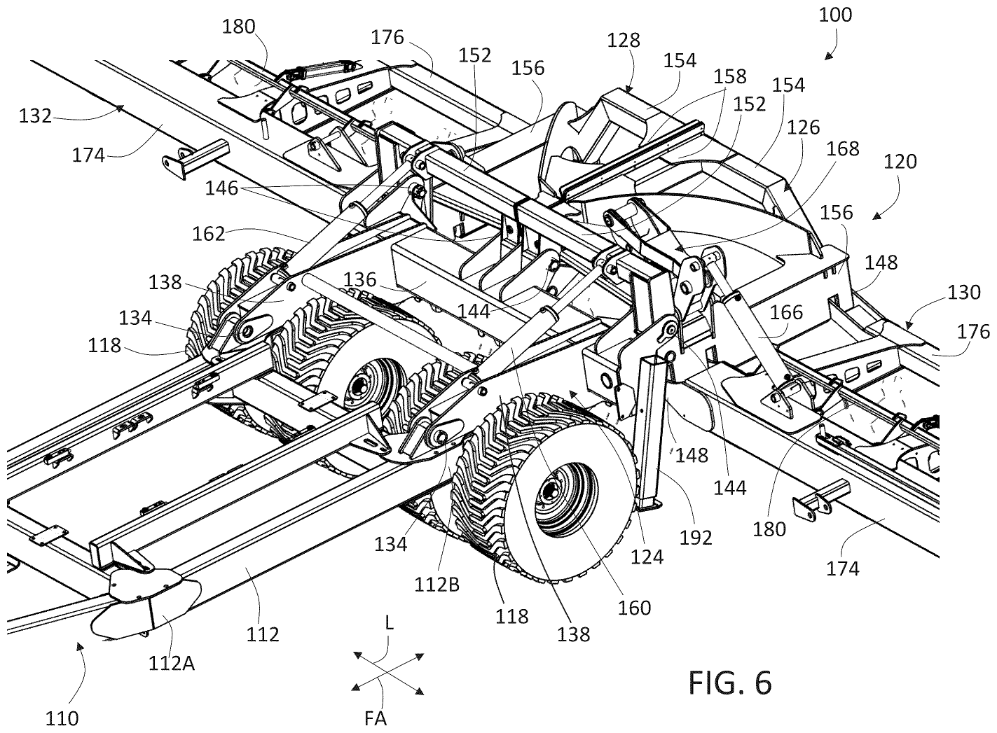

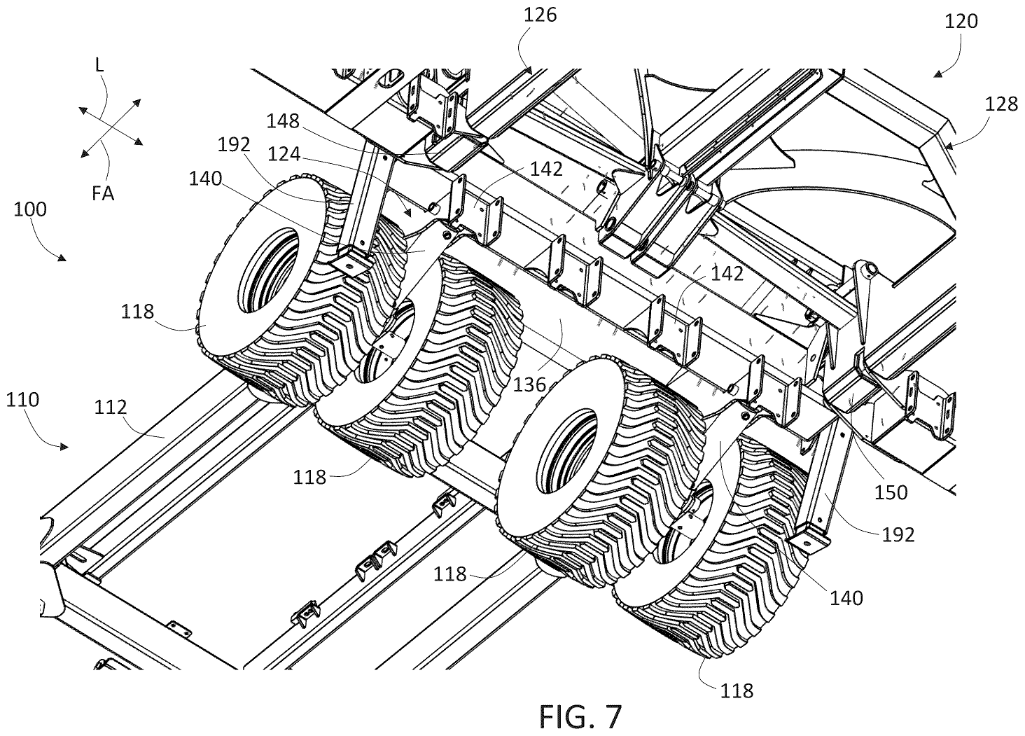

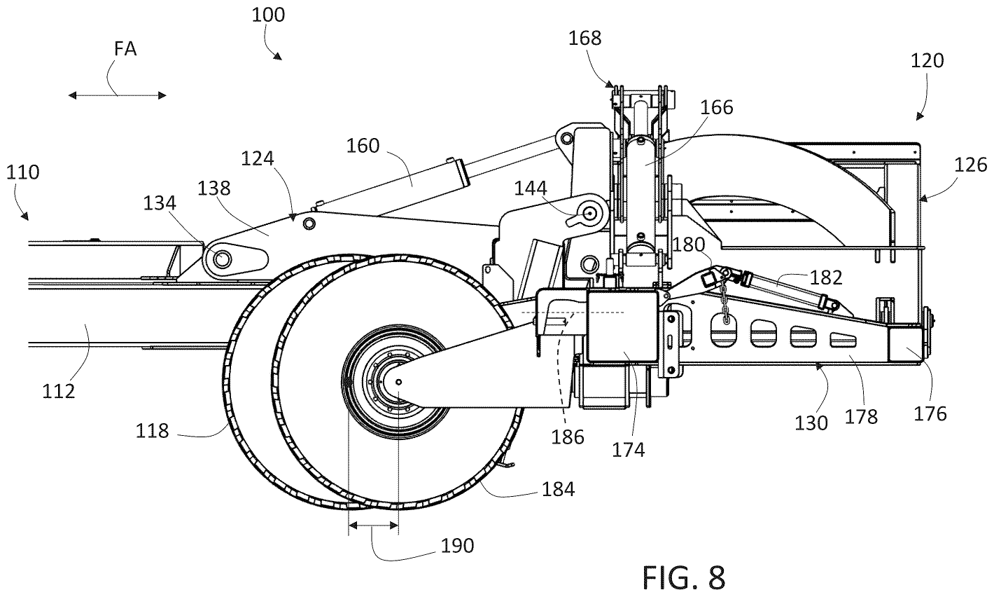

Referring now to the drawings, FIGS. 1-8 illustrate several views of one embodiment of an agricultural implement 100 in accordance with aspects of the present subject matter. Specifically, FIG. 1 illustrates a perspective view of the agricultural implement 100, while FIGS. 2-8 illustrate numerous other views of the implement 100 with various components removed therefrom for purposes of illustration. For example, FIG. 2 illustrates a rear perspective view of the implement with a storage tank and row units of the implement 100 removed for purposes of illustration, with FIGS. 3 and 4 illustrating zoomed-in portions of the perspective view of the implement 100 shown in FIG. 2. Specifically, FIG. 3 illustrates a zoomed-in, perspective view of a central portion of a toolbar assembly of the implement 100 and FIG. 4 illustrates a zoomed-in perspective view of a more outboard portion of the toolbar assembly of the implement 100. Additionally, FIG. 5 illustrates a front perspective view of the implement with the storage tank and row units of the implement 100 removed for purposes of illustration, with FIG. 6 illustrating a zoomed-in view of the central portion of the toolbar assembly of the implement 100 shown in FIG. 5. Moreover, FIG. 7 illustrates a bottom perspective view of the central portion of the toolbar assembly shown in FIG. 6, while FIG. 8 illustrates a side view of an aft portion of the implement 100 shown in FIGS. 2 and 5.

In general, the implement 100 may be configured to be towed across a field in a forward direction of travel (e.g., as indicated by arrow 102 in FIGS. 1, 2, and 5) by a work vehicle (e.g., an agricultural tractor). As shown, the implement 100 is configured as a strip tillage implement. However, in other embodiments, the implement 100 may be configured as any other suitable type of implement, such as a seed-planting implement, a fertilizer-dispensing implement, and/or the like.

As generally shown in FIGS. 1, 2, and 5, the implement 100 includes a chassis assembly 110 and a toolbar assembly 120 coupled to the chassis assembly 110. In several embodiments, the chassis assembly 110 may include both a support frame 112 and a towbar 114. As shown in FIG. 6, the support frame 112 may extend in a fore-aft direction of the implement 100 (as indicated by arrow FA in FIGS. 1-8) between a forward end 112A and an aft end 112B, with the towbar 114 extending outwardly from the forward end 112A of the support frame 112 to allow the implement 100 to be towed by a work vehicle (not shown). As shown in FIG. 1, the support frame 112A may, in one embodiment, be configured to support one or more storage tanks 116 between its forward and aft ends 112A, 112B. For instance, the storage tank(s) 116 may correspond to a fertilizer tank or any other suitable type of storage tank configured to store an agricultural material. The chassis assembly 110 may also be coupled to one or more pairs of chassis support wheels 118. For example, as particularly shown in FIGS. 5 and 6, two pairs of support wheels 118 may be coupled to the aft end 112B of the support frame 112 to support the implement 100 relative to the ground.

As shown in FIG. 6, the toolbar assembly 120 may generally be configured to be coupled to the support frame 112 at its aft end 112B such that the toolbar assembly 120 trails the chassis assembly 110 in the fore-aft direction FA. In general, the toolbar assembly 120 may be configured to support a plurality of row units 122 (e.g., as shown in FIG. 1). Specifically, in the illustrated embodiment, the row units 122 are configured as strip tillage units. As such, each row unit 122 may include one or more ground-engaging tools for working the soil in narrow strips extending in the for-aft-direction FA. For instance, in one embodiment, each row unit 122 may include one or more row cleaner disks, coulter disks, shanks or knives, finishing or conditioning units, and/or the like for tilling narrow strips of soil during the performance of a strip tillage operation. Additionally, each row unit 122 may also incorporate one or more components for supplying agricultural materials to the soil, such as injectors or tubes for directing the agricultural material (e.g., fertilizer) supplied from the storage tank 116 into the worked soil.

As generally shown in FIGS. 1, 2 and 5, the toolbar assembly 120 may include a central toolbar section 124, a pair of wing roll sections (e.g., a first or right wing roll section 126 and a second or left wing roll section 128), and a corresponding pair of wing toolbar sections (e.g., a first or right wing toolbar section 130 and a second or left wing toolbar section 132). As is generally understood, the toolbar sections 124, 130, 132 may generally be configured to support the row units 122 relative to the remainder of the implement 10. For instance, in one embodiment, each row unit 122 may be coupled to its respective toolbar section 124, 130, 132 via a four-bar linkage.

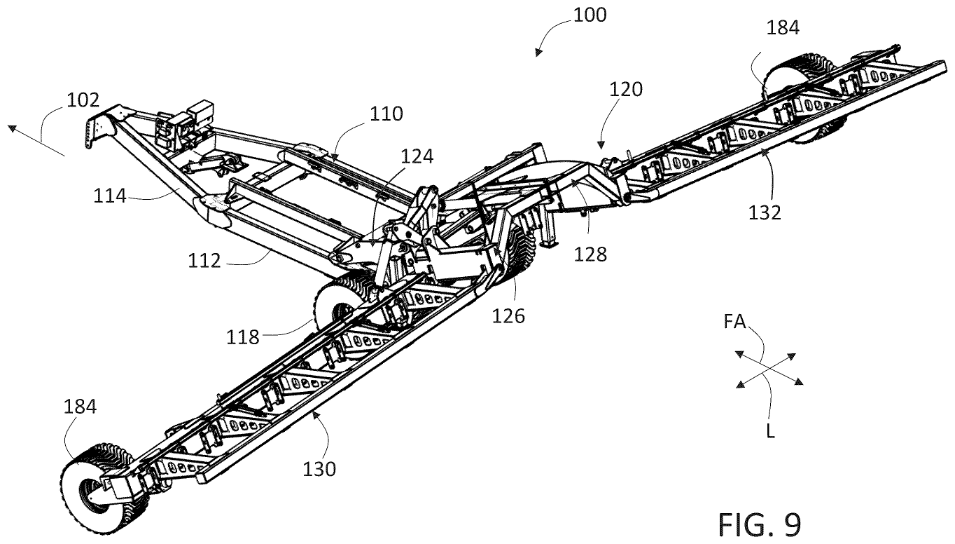

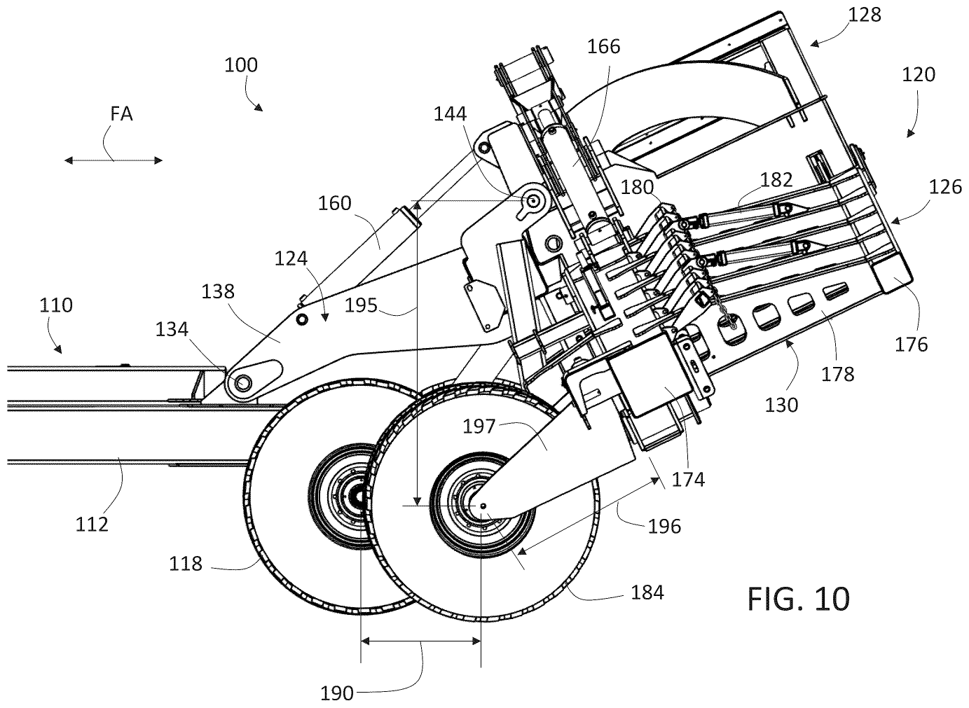

As particularly shown in FIG. 6, the center toolbar section 124 may generally be pivotally coupled to the chassis assembly 110 (e.g., via the support frame 112) at a pair of forward toolbar pivot joints 134 to allow the toolbar assembly 120 to be pivoted vertically relative to the chassis assembly 112 between a working position (e.g., as shown in FIGS. 1-8) and a headland position (e.g., as shown in FIGS. 9 and 10). For instance, as shown in FIG. 6, the center toolbar section 124 may include a central toolbar member 136 extending in a lateral direction of the implement 100 (e.g., as indicated by arrow L in FIGS. 1-7) and a pair of pivot arms 138 extending forwardly from the central toolbar member 136 in the fore-aft-direction FA, with the pivot arms 138 being pivotably coupled to the aft end 112b of the support frame 112 at the forward toolbar pivot joints 134. As particularly shown in the bottom perspective view of FIG. 7, a pair of lift cylinders 140 may also be coupled between the chassis assembly 110 (e.g., at a location between each pair of chassis support wheels 118, such as at an axle tube extending between the wheels 118) and the center toolbar section 124 (e.g., via the central toolbar member 136) to allow the toolbar assembly 120 to be pivoted upwards or downwards relative to the chassis assembly 110 about the forward toolbar pivot joints 134. Additionally, as shown in FIG. 7, the central toolbar member 136 may include or be coupled to suitable mounting brackets 142 for coupling any number of row units 122 into the central toolbar member 136. For instance, referring back to FIG. 1, in one embodiment, four row units 122 may be coupled to and supported by the central toolbar member 136. However, in other embodiments, any other suitable number of row units 122 may be coupled to and supported by the central toolbar member 136.

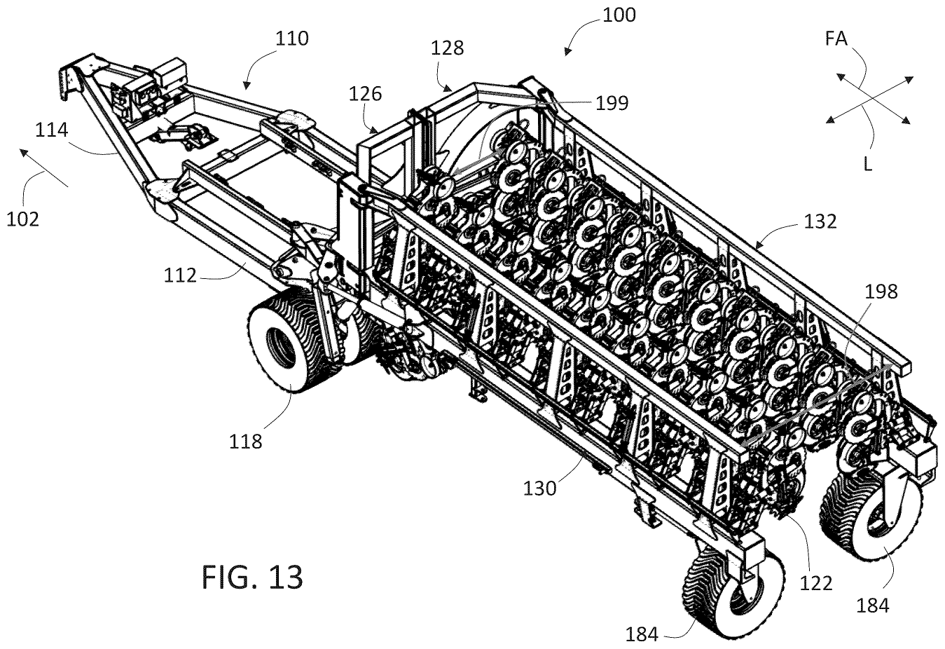

As indicated above, the toolbar assembly 120 includes a pair of wing roll sections 126, 128, particularly a first or right wing roll section 126 and a second or left wing roll section 128, and a corresponding pair of wing toolbar sections 130, 132, namely a first or right wing toolbar section 130 and a second or left wing toolbar section 132. In general, each wing roll section 126, 128 may be configured to be coupled between the central toolbar section 124 and its respective wing toolbar section 130, 132 in a manner that allows: (1) the wing roll section 126, 128 and corresponding wing toolbar section 130, 132 to be rolled or pivoted upwardly and downwardly relative to the center toolbar section 124 about respective wing roll pivot joints 144, 146 (e.g., see FIG. 6); and (2) each wing toolbar section 130, 132 to be folded relative to its respective wing roll section 126, 128 about wing fold pivot joints 148, 150 (e.g., see FIGS. 3, 4, and 6) between an extended or unfolded position (e.g., as shown in FIGS. 1-8) and a rearwardly folded position (e.g., as shown in FIG. 13).

To provide such an independent connection between the central toolbar section 124 and the respective wing toolbar sections 130, 132, each wing roll section 126, 128 may generally include an assembly or plurality of support or frame members that is separate or distinct from the support or frame members of the other wing roll section 126, 128. For instance, as particularly shown in FIGS. 3 and 6, each wing roll section 126, 128 may include laterally extending forward and aft support members 152, 154 spaced apart in the fore-to-aft direction FA of the implement 10. As will be described below, in one embodiment, the aft support member 154 of each wing roll section 130, 132 may have an arced profile to provide clearance for the row units 122 during operation, folding, and/or during transport of the implement 100. Additionally, as particularly shown in FIGS. 3 and 6, each wing roll section 130, 312 may include a pair of fore-to-aft support members 156, 158 extending between its respective forward and aft support members 152, 154. Specifically, in the illustrated embodiment, each wing roll section 126, 128 includes an outer support member 156 extending in the fore-to-aft direction FA between the forward and aft support members 152, 154 adjacent to the interface between the wing roll section 126, 128 and its respective wing toolbar section 130, 132 and an inner support member 158 extending in the fore-to-aft direction FA between the forward and aft support members 152, 154 adjacent to the interface between the wing roll section 126, 128 and the adjacent wing roll section 128, 130. As will be described below, a sliding interface may be provided between the inner support members 158 of the adjacent wing roll sections 126, 128 to allow each wing roll section 126, 128 to move independently of the other wing roll section 126, 128 during operation, folding, and/or transport of the implement 100. Additionally, the inner support members 158 of the wing roll sections 126, 128 may be configured to compress against one another when the implement 100 is in the working position to provide strength to the toolbar assembly 100 and suitable structure to account for the rearward, inward moment applied against the wing toolbar sections 130, 132 during operation. Specifically, the contact/compression between the inner support members 158 of the wing roll sections 126, 128 may bridge the load applied against wing toolbar sections 130, 132 across the interface defined between the wing roll sections 126, 128.

Referring specifically to FIG. 6, each wing roll section 126, 128 may be separately coupled to the central toolbar section 124 at a respective pair of wing roll pivot joints 144, 146. Specifically, the forward support member 152 of the first wing roll section 126 is pivotably coupled to the central toolbar section 124 at a pair of first wing roll pivot joints 144, while the forward support member 152 of the second wing roll section 128 is pivotably coupled to the central toolbar section 124 at a pair of second wing roll pivot joints 146. Additionally, a respective roll cylinder 160, 162 is coupled between each wing roll section 126, 128 and the central toolbar section 124 to allow the wing roll sections 126, 128 to be independently pivoted upwards or downwards relative to the central toolbar section 124 about the respective wing roll pivot joints 144, 146. Specifically, as shown in FIG. 6, a first roll cylinder 160 is coupled between the forward support member 152 of first wing roll section 126 and the central toolbar section 124 (e.g., via the adjacent pivot arm 138 of the central toolbar section 124) and a second roll cylinder 162 is coupled between the forward support member 152 of the second wing roll section 128 and the central toolbar section 124 (e.g., via the adjacent pivot arm 138 of the central toolbar section 124).

Moreover, as indicated above, each wing roll section 126, 128 is configured to be pivotably coupled to its respective wing toolbar section 130, 132 at wing fold joints 148, 140 to allow the wing toolbar section 130, 132 to be folded relative to the wing roll section 126, 128 between unfolded and folded positions. For instance, as shown in FIG. 3, the first wing toolbar section 130 is pivotably coupled to the outer support member 156 of the first wing roll section 130 at a respective pair of first wing fold pivot joints 148 (only one of which is visible in FIG. 3, the second being shown in the bottom view of FIG. 7) while the second wing toolbar section 132 is pivotably coupled to the outer support member 156 of the second wing roll section 128 at a respective pair of second wing pivot joints 150 (only one of which is visible in FIG. 3, the second being shown in the bottom view of FIG. 7). Additionally, in one embodiment, each wing roll section 126, 128 may be further connected to its respective wing toolbar section 130, 132 via a pair of fold cylinders 164, 166 and a corresponding four-bar linkage 168 that is coupled to the outer support member 156 of the respective wing roll section 126, 128. Specifically, as shown in FIG. 3, an inner fold cylinder 164 is coupled between the inner support member 158 of the first wing roll section 126 and an inner linkage 170 of the associated four-bar linkage 168 and an outer fold cylinder 166 is coupled between an outer linkage 172 of the four-bar linkage 168 and the first wing toolbar section 130. Although not shown in FIG. 3, a similar pair of fold cylinders and associated four-bar linkage may be used to couple the second wing roll section 128 to the second wing toolbar section 132. As will be described below, the fold cylinders 164, 166 may be extended/retracted as needed to permit folding and unfolding of the wing toolbar sections 130, 132 relative to the wing roll sections 126, 128 about the fold pivot joints 148, 150. In this regard, the four-bar linkage 168 provided between each pair of fold cylinder 164, 166 may function to extend or increase the range of fold angles about which the wing toolbar sections 130, 132 may be pivoted relative to the wing roll sections 126, 128. For instance, in one embodiment, the combination of each pair of fold cylinders 164, 166 and the associated four-bar linkage 160 may allow for greater than 90 degrees of pivoting between the wing toolbar sections 130, 132 and the wing roll sections 126, 128, such as greater than 110 degrees of pivoting or greater than 120 degree of pivoting or greater than 130 degrees of pivoting or greater than 140 degrees of pivoting.

In several embodiments, the wing toolbar sections 130, 132 may have a ladder-type configuration. Specifically, as shown in FIGS. 4 and 8, each wing toolbar section 130, 132 may include a laterally extended forward toolbar member 174, a laterally extended aft toolbar member 176, and a plurality of cross-support members or rungs 178 extending in the fore-aft-direction FA between the forward and aft toolbar members 174, 176 to provide the wing toolbar section 130, 132 with a rigid, frame-like configuration. In one embodiment, the forward toolbar member 174 of each wing toolbar section 130, 132 may be coupled to the adjacent wing roll section 126, 128 at the forwardmost wing fold pivot joint 148, 150 defined between such sections, while the aft toolbar member 176 of each wing toolbar section 174, 176 may be coupled to the adjacent wing roll section 126, 128 at the rearward most wing fold pivot joint 148, 150 defined between such sections. The ladder-type configuration of the wing toolbar sections 130, 132 may provide suitable strength and rigidity for the toolbar assembly 100 during the performance of a strip tillage operation.

It should be appreciated that each toolbar member 174, 176 may be configured to be coupled to and support a plurality of row units 122. For instance, in the embodiment shown in FIG. 1, the row units 122 are coupled to the forward toolbar member 174 of each wing toolbar section 130, 132. However, in other embodiments, the row units 122 may be coupled to the aft toolbar member 176 of each wing toolbar section 130, 132 or may be coupled to both toolbar members 174, 176 (e.g., in a staggered or alternating arrangement).

In several embodiments, a rockshaft 180 may be pivotably coupled to a portion of each wing toolbar section 130, 132. For example, as shown in FIGS. 4 and 8, a rockshaft 180 may be pivotably coupled to the forward toolbar member 174 of the first wing toolbar section 130 (e.g., at a plurality of pivot joints) and may extend laterally across the length of the wing toolbar section 130. A similar rockshaft may also be provided in association with the second wing toolbar section 132. Additionally, as shown in the illustrated embodiment, one or more rockshaft cylinders 182 may be coupled between the rockshaft 180 and the wing toolbar section 130, 132 to allow the rockshaft 180 to be pivoted relative to the toolbar section 130, 132. As will be described below, in one embodiment, each row unit 122 supported by a given wing toolbar section 130, 132 may be coupled to the rockshaft 180 installed on such toolbar section 130, 132 (e.g., via chains or any other suitable coupling), thereby allowing the row units 122 to be pivoted relative to the toolbar section 130, 132 when transitioning the implement 100 to the transport position. For instance, the rockshaft cylinders 182 may be actuated as part of the folding procedure to allow the row units 122 of each wing toolbar section 130, 132 to be pulled or pivoted away from the row units 122 of the other wing toolbar section 130, 132 when such sections are in their rearwardly oriented, folded positions.

Moreover, as shown in FIGS. 1, 2, 4, 5, and 8, a wing support wheel 184 may be coupled to each wing toolbar section 130, 132 (e.g., at the front of each wing toolbar section 130, 132) to support the toolbar section 130, 132 relative to the ground. In one embodiment, each wing support wheel 184 may be pivotably coupled to its respective wing toolbar section 130, 132 about a pivot axis 186 (FIG. 8) that is oriented in a horizontal direction when the implement 100 is in the lowered, working position (e.g., as shown in FIG. 8). However, as the implement 100 is transitioned from the working position to the transport position during execution of the folding procedure, the orientation of the pivot axis 186 will transition from a horizontal orientation to a vertical orientation, thereby allowing the wheel 184 to be pivoted about the vertical axis 186 to reposition the wheel 184 for rolling along the ground when the implement 100 is being towed in the transport position. As shown in FIGS. 4 and 5, to permit such pivoting of the wheel 184 about the pivot axis 186, a wheel pivot cylinder 188 may be coupled between the wheel 184 and its respective wing toolbar section 130. 132. As such, by retracting/extending the cylinder 188, the wheel 184 may be pivoted about the pivot axis 186 when in the transport position. It should be appreciated that the wing support wheels 184 shown in the illustrated embodiment are non-caster wheels. As such, the wheels 184 do not pivot about vertical axis when the implement 100 is in the working position.

As particularly shown in FIG. 8, in one embodiment, the rotational axes of the wing support wheels 184 may be configured to be spaced apart from the rotational axis of the chassis support wheels 118 in the fore-to-aft direction FA by a wheel spacing distance 190. In several embodiments, it may be desirable to maintain this wheel spacing distance 190 within a given distance range when transitioning the implement 100 from the working position to the headland position. For instance, in several embodiments, the wheel spacing distance 190 may be maintained within a distance range of from greater than zero inches to less than about 30 inches as the toolbar assembly 120 is being pivoted relative to the chassis assembly 100 from the working position to the headlands position.

Additionally, as particularly shown in FIGS. 5-7, the implement 100 may also include a pair of jack stands 192 coupled to a portion of the toolbar assembly 120 (e.g., the wing roll sections 126, 128) for supporting the implement 100 when it is disconnected from the towing vehicle. For instance, with the toolbar assembly 120 in the transport position, the jack stands 192 may be lowered to help support the weight of the wing toolbar sections 130, 132 and eliminate any negative tongue weight on the towbar 114.

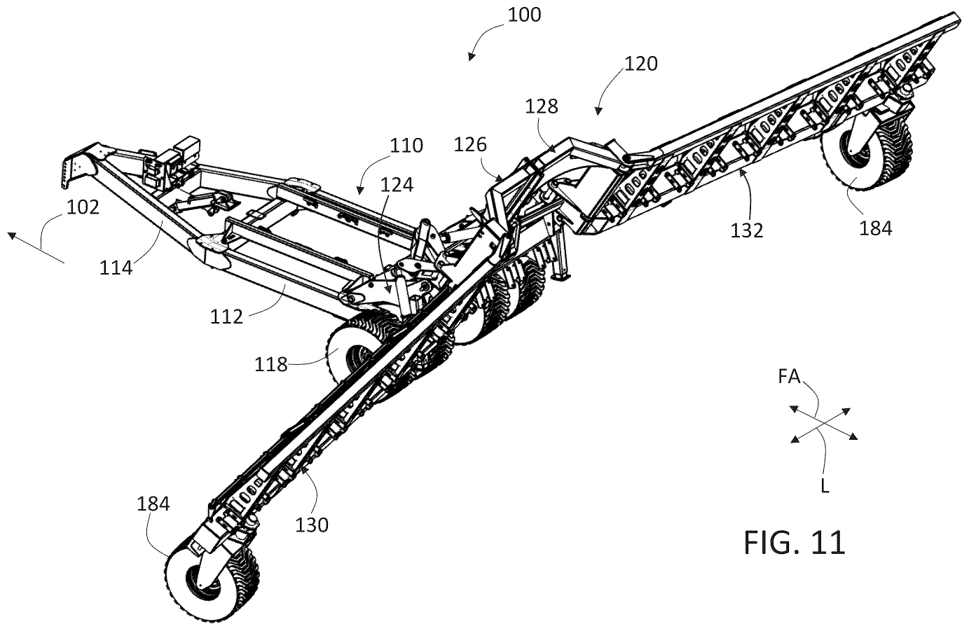

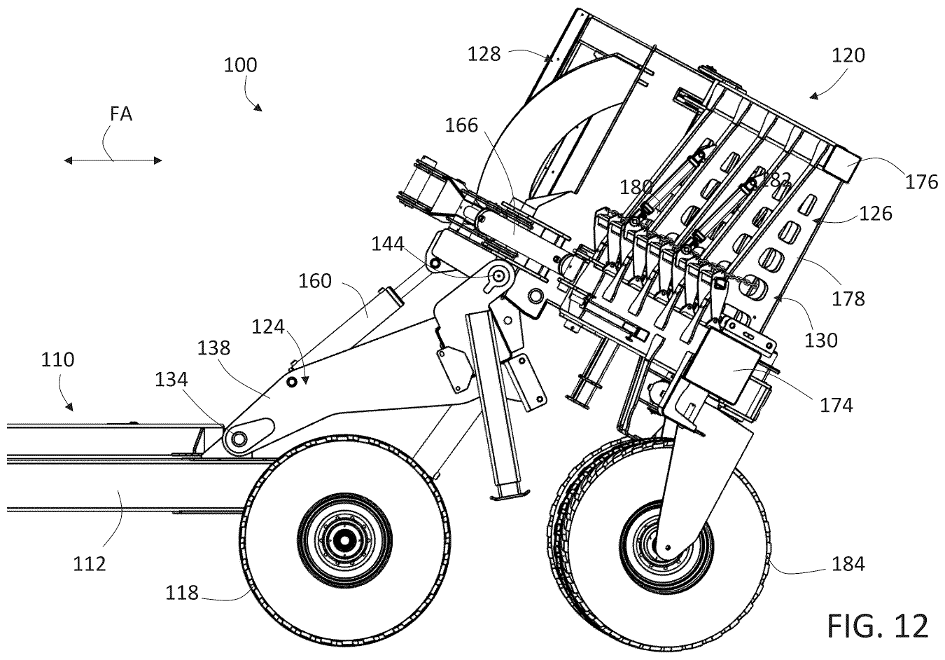

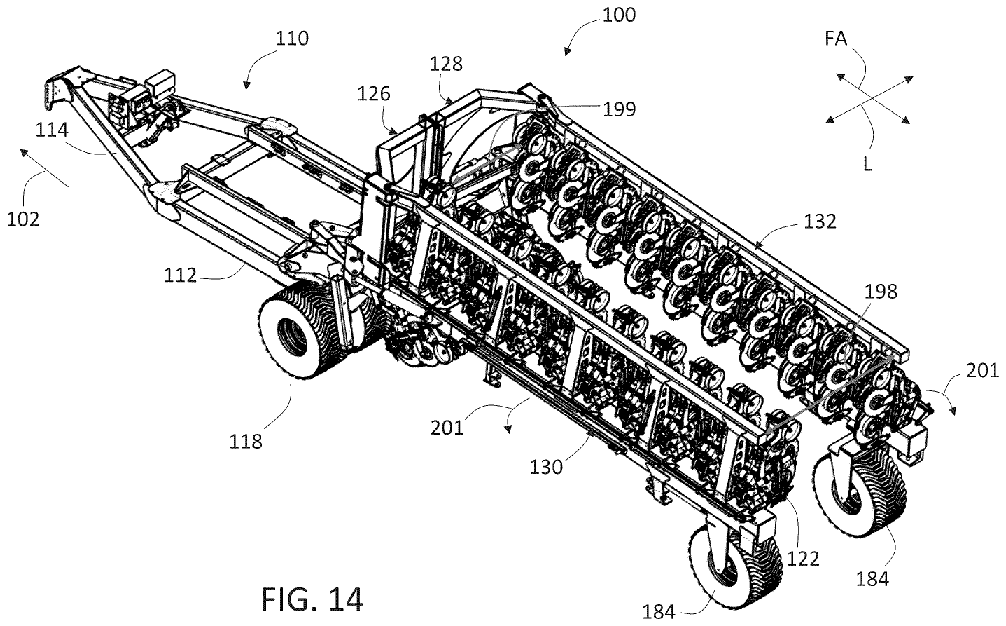

The folding procedure of the agricultural implement 100 will now be described with reference to FIGS. 2 and 8-14. As indicated above, FIGS. 2 and 8 illustrate perspective and partial side views, respectively, of the implement 100 with the toolbar assembly 120 in a lowered, working position. FIGS. 9 and 10 illustrate similar perspective and partial side views, respectively, of the implement 100 after the toolbar assembly 120 has transitioned from the working position to a headland position. Additionally, FIGS. 11 and 12 illustrate similar perspective and partial side views, respectively, of the implement 100 after the toolbar assembly 120 has transitioned from the headland position to a lift/fold transition position. Moreover, FIG. 13 illustrates a perspective view of the implement 100 after the transport assembly 120 has transitioned from the lift/fold transition position to a rearwardly folded position, while FIG. 14 illustrates a perspective view of the implement 100 after the transport assembly 120 has transitioned from the rearwardly folded position to a transport position.

### Folding Sequence-Working Position to Headland Position

As particularly shown in FIGS. 2 and 8, when in the working position, the transport assembly 120 generally has a horizontal orientation, with the wing toolbar sections 130, 132 being generally oriented parallel to the ground and perpendicular to the fore-aft direction FA. Additionally, when in the working position, the wing support wheels 184 are generally spaced apart from the chassis support wheels 118 by a minimum wheel spacing distance 190 (FIG. 8). For instance, in one embodiment, the wheel spacing distance at the working position may be between zero inches and less than 12 inches, such as less than 10 inches, or less than 8 inches, or less than 6 inches or any other subranges therebetween. Moreover, when in the working position, the wing fold cylinders 164, 166 are generally configured to be in a float mode while the remainder of the cylinders (e.g., the lift cylinders 140 and roll cylinders 160, 162) are locked out and, thus, prevented from extending or retracting. Additionally, when in the headlands position, the wing fold cylinders 164, 166 are maintained in the float mode to allow the wing support wheels 184 to follow the contour of the ground as a headland turn is being executed.

To transition from the working position to the headland position, the lift cylinders 140 are actuated such that the entire toolbar assembly 120 is pivoted upwardly relative to the chassis assembly 110 about the forward toolbar pivot joints 134. For instance, as shown in the transition between FIG. 8 and FIG. 10, the toolbar assembly 120 has been pivoted upwardly relative to the chassis assembly 110 to the headland position to raise the row units 122 (see FIG. 1) out of the ground. In such position, as shown in FIG. 10, the wing toolbar sections 130, 132 are oriented upwardly in the fore-aft direction FA such that the aft toolbar member 176 of each wing toolbar section 130, 132 is positioned higher than the forward toolbar member 174 of each wing toolbar section 130, 132. Additionally, at such position, the wing toolbar sections 130, 132 are configured to droop downwardly or otherwise angled downwardly in the lateral direction L when the toolbar assembly 120 is in the headland position. For instance, as shown in FIG. 10, the innermost end of each wing toolbar section 130, 132 (i.e., the end coupled to the respective wing roll section 126, 128) is positioned higher than the outermost end of each wing toolbar section 130, 132 (i.e., the end positioned furthest outboard from the respective wing roll section 126, 128) such that the wing toolbar section 130, 132 is angled downwardly in the lateral direction L as it extends outwardly from the wing roll section 126, 128.

Moreover, as shown in the transition between FIG. 8 and FIG. 10, the wing support wheels 184 roll backwards relative to the chassis support wheels 118 as the toolbar assembly 120 is moved between the working position and the headland position such that the wheel spacing distance 190 is increased. In one embodiment, the maximum wheel spacing distance 190 at the headland position is less than 30 inches, such as less than 28 inches or less than 26 inches or less than 24 inches. In general, as the wheel spacing distance 190 at the headland position is reduced, the ability for the implement 100 to make effective turns in the headlands is increased.

### Folding Sequence—Headland Position to Lift/Fold Transition Position

Once the transport assembly 120 has reached the headland position, the lift cylinders 140 are locked out and the roll and fold cylinders 160, 162, 164, 166 are actuated to initiate the transition of the toolbar assembly 120 towards the rearwardly folded position (e.g., as shown in FIG. 13). In doing so, upon actuation of the roll and fold cylinders 160, 162, 164, 166, the roll cylinders 160, 162 initially provide the primary motive force to cause the wing roll sections 126, 128 (and the wing toolbar sections 130, 132 coupled thereto) to pivot upwardly relative to the central toolbar section 136 about the wing roll pivot joints 144, 146. As the wing roll sections 126, 128 pivot upwardly, the force of gravity pulling downwardly on the wing toolbar sections 130, 132 (together with the fold cylinders 164, 164) generally causes the wing toolbar sections 130, 132 to pivot relative to the wing roll sections 126, 128 about the wing fold pivot joints 148, 150. Once the wing roll sections 126, 128 have been pivoted upwardly relative to the central toolbar section 124 to the lift/fold position shown in FIGS. 11 and 12, the fold cylinders 164, 166 generally take over to fold the wing toolbar sections 130, 132 rearwardly relative to the wing roll sections 126, 128 about the wing fold pivot joints 148, 150.

It should be appreciated that, when transitioning the toolbar assembly 120 from the headland position to the lift/fold transition position, the wing support wheels 184 are moved rearwardly from a position forward of the wing roll pivot joints 144, 146 to a position aft of such pivot joints 144, 146. In this regard, a vertical clearance distance 195 (FIG. 10) between the wing roll pivot joints 144, 146 and the wing support wheels 184 must be carefully selected to allow the wing support wheels 184 to be rolled backwards past the location of the wing roll pivot joints 144, 146 without lifting the entire toolbar assembly 120. Such distance can be impacted by the vertical positioning of the wing roll pivot joints 144, 146 relative to the ground and/or a bracket length 196 (FIG. 10) of wing wheel brackets 197 (FIG. 10) used to couple the wing support wheels 184 to the respective wing toolbar sections 130, 132.

### Folding Sequence—Lift/Fold Transition Position to Rearwardly Folded Position

As shown in the transition between FIG. 11 and FIG. 13, the fold cylinders 164, 166 generally function to fold the wing toolbar sections 130, 132 rearwardly relative to the wing roll sections 126, 128 to the rearwardly folded position at which the wing toolbar sections 130, 132 are generally oriented perpendicular to the wing roll sections 126, 128 (and generally parallel to the fore-aft direction FA). At such position, a lateral wing spacing distance 198 is generally defined between the first and second wing toolbar sections 130, 132. In one embodiment, a tie rod or other connecting member (not shown) may be coupled between the first and wing toolbar sections 130, 132 to fix this wing spacing distance 198. For instance, a rigid tie rod may be coupled between the outermost ends of the wing toolbar sections 130, 132 to set the wing spacing distance 198 at such location. Additionally, when at the rearwardly folded position (and prior to transition to the final transport position), the row units 122 may have a minimal lateral spacing distance 199 defined therebetween.

### Folding Sequence—Rearwardly Folded Position to Transport Position

To transition the toolbar assembly 120 from the rearwardly folded position to the transport position, the wing wheel cylinders 188 may be actuated to rotate or pivot the wing support wheels 184 about their now vertical pivot axes to reorient the wheels 184 in the fore-aft direction FA. For instance, as shown in the transition between the FIGS. 13 and 14, the wing support wheels 184 have been actuated to allow the wheels 184 to roll in the fore-aft-direction FA during transport of the implement 100. It should also be appreciated that the wing support wheels 184 roll backward continuously relative to the chassis assembly 110 during the entire transition from the working position to the rearwardly folded position. Once at the rearwardly folded position, the wing support wheels 184 have reached their rearwardmost fore-aft position, at which point the wheels 184 may be reoriented via actuation of the wing wheel cylinders 188.

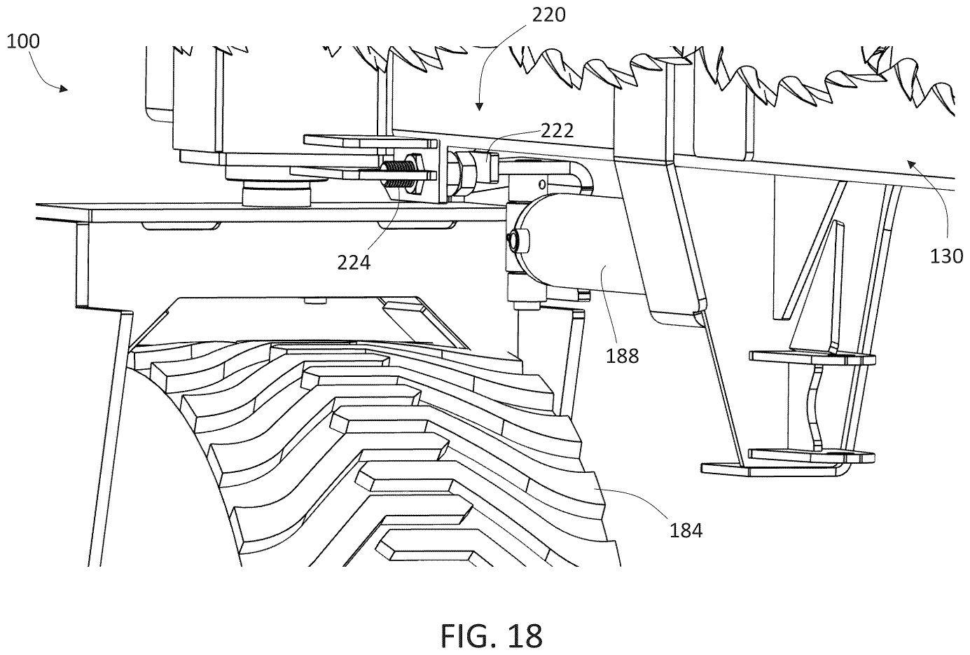

It should also be appreciated that, in one embodiment, each toolbar assembly 120 may include an adjustable wheel stop assembly 220 (FIG. 18) associated with the wing support wheel 184 to provide a mechanical stop for the wheel 184 as it is being reoriented in the transport position. For instance, as shown in the perspective view of FIG. 18, an adjustable stop assembly 220 is provided that includes a stop member 222 (e.g., a stop bracket or tab coupled to the pivot joint for the wheel 184) and an adjustment member 224 (e.g., a bolt or other suitable adjustment member coupled to the toolbar assembly 130). In such an embodiment, the position of the adjustment member 224 can be varied, as desired, to adjust the stop position for the wheel 184 (i.e., where the stop member 222 contracts the adjustment member 224) in the transport position.

Additionally, to provide clearance between the row units 122 during transport (e.g., during the execution of turns), the rockshaft cylinders 182 may be actuated to cause the rockshafts 180 to pivot outwardly relative to the wing toolbar sections 130, 132 (e.g., in the direction shown by arrows 201 in FIG. 14). As indicated above, each row unit 122 supported by one of the wing toolbar sections 130, 132 may be coupled to the rockshaft 180 via a chain or other suitable coupling. As a result, when the rockshafts 180 are pivoted outwardly relative to the wing toolbar sections 130, 132, the row units 122 of each wing toolbar section 1130, 132 may be pulled laterally away from the row units 122 of the other wing toolbar section 130, 132. This causes the lateral spacing distance 199 defined between the row units 122 of each wing toolbar section to be increased, thereby providing additional clearance for executing turns during transport.

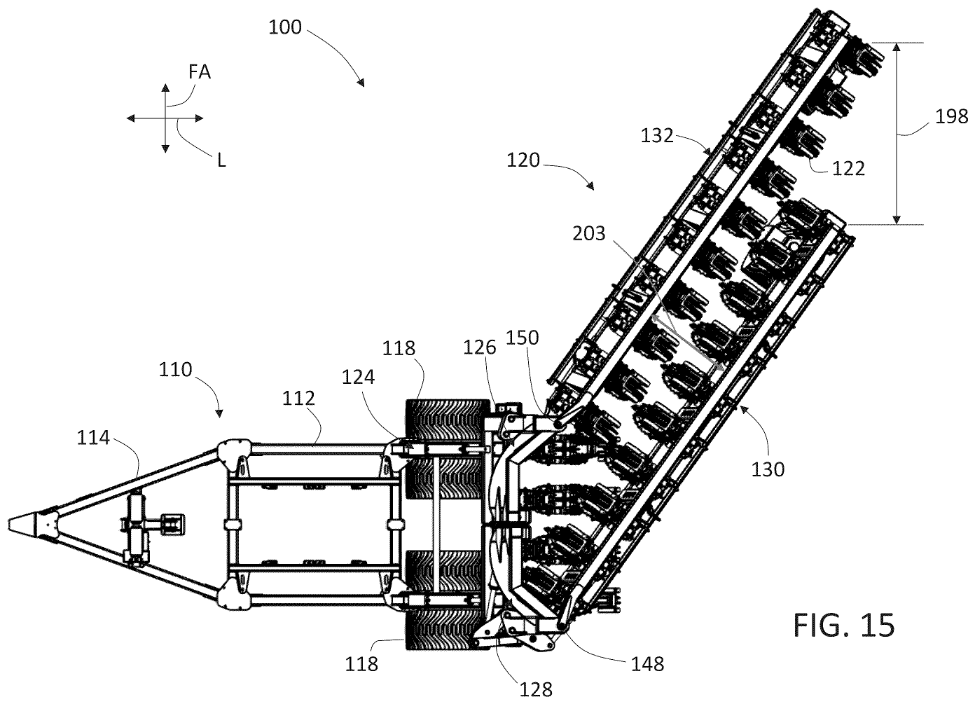

As an example, FIG. 15 illustrates a top view of the implement 100 in the transport position when executing a narrow turn. As the towing vehicle is making a turn, the wing toolbar sections 130, 132 pivot relative to the wing roll sections 126, 128 about their wing fold pivot joints 144, 146 from the for-aft orientation shown in FIG. 14 to the skewed orientation shown in FIG. 15. For instance, each wing toolbar section 130, 132 may, in one embodiment, be configured to pivot relative to its respective wing roll section 126, 128 from the fore-aft orientation shown in FIG. 15 an additional amount of up to or exceeding 50 degrees. In such an embodiment, a fold range of the wing toolbar sections 130, 132 relative to the wing roll sections 126, 128 from the working position to the position shown in FIG. 15 may be equal to or exceed 140 degrees. To allow for such folding, the wing fold cylinders 164, 166 may be maintained in a float mode during transport.

It should be appreciated that, when the wing toolbar sections 130, 132 are oriented in the manner shown in FIG. 15, an interior wing-to-wing spacing distance 203 extending perpendicular to the wing toolbar sections 130, 132 may be significantly smaller than the lateral wing spacing distance 198 defined between the wing tool bar sections 130, 132. However, when the wing toolbar sections 130, 132 are oriented in the manner shown in FIG. 14, the interior wing-to-wing spacing distance 203 is the same as the lateral wing spacing distance 198. Accordingly, the ability to increase the lateral spacing between the row units 122 by actuating the rockshafts 180 (and, thus, pulling the separate sets of row units 122 away from one another in the lateral direction L) allow for the maximum turning radius of the implement 100 to be increased without causing the row units 122 to contact one another as the implement 100 is being turned. Additionally, it should be appreciated that the arced shape of the aft support member 154 of each wing roll section 126, 128 may allow for the innermost row unit 122 on each wing toolbar section 126, 128 to fold with its toolbar section 130, 132 to the position shown in FIG. 15 without the row unit 122 contacting the adjacent wing roll section 126, 128.

It should also be appreciated that, due to the ability of the wing roll sections 126, 128 to pivot independently about their respective wing roll pivot joints 144, 146, the wing roll sections 144, 146 may move relative to one another during transport of the implement 100 (e.g., by maintaining both roll cylinders 160, 162 in a float mode during transport). Thus, when only one of the wing toolbar sections 130, 132 encounters a lowered area (e.g., a depression or ditch) or raised area (e.g., a bump or hill) during transport, the wing roll section 126, 128 associated with such wing toolbar section 130, 132 can move independently of the other wing roll section 130, 132 to accommodate raised or lowering of the wing toolbar section 130, 132 as its corresponding wing support wheel 184 encounters such raised/lowered areas.

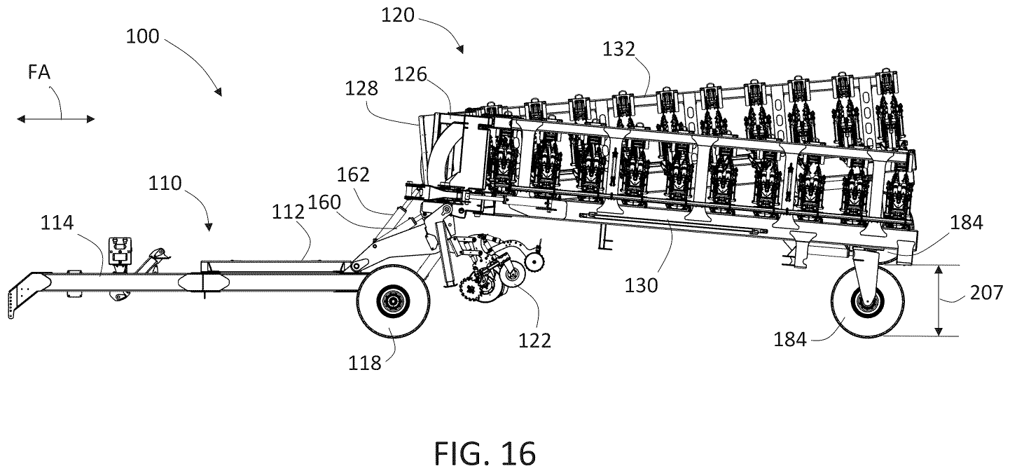

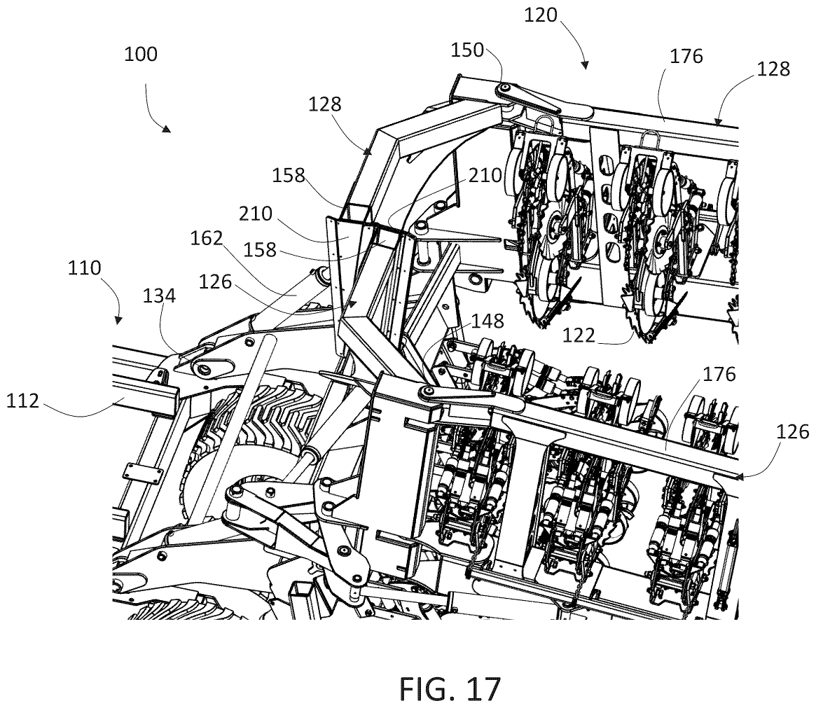

For example, FIGS. 16 and 17 illustrate the toolbar assembly 120 in the transport position while one of the wing toolbar sections (i.e., the second wing toolbar section 132) is raised relative to the other wing toolbar section (i.e., the first wing toolbar section 130). Specifically, FIG. 16 illustrates a side view of the implement 100 with the toolbar assembly 120 in the transport position and the second wing toolbar section 132 raised relative to the first wing toolbar section 130 and FIG. 17 illustrates a zoomed-in perspective view of the wing roll sections 126, 128 of the implement 100 with the wing toolbar sections 130, 132 being offset vertically in the manner shown in FIG. 16. As shown in FIG. 16, the wing support wheel 184 of the second wing toolbar section 132 is offset vertically from the wing support wheel 184 of the first wing toolbar section 130 by a given vertical distance 207. This may occur, for example, if the second wing toolbar section 132 encounters a hill, upwardly slopped surface or other raised area while the first wing toolbar section 130 remains on relatively flat or planar ground. In such instance, as shown in FIG. 17, the second wing roll section 128 may pivot relative to the first wing roll section 128 to accommodate such upward travel of the second wing toolbar section 132 relative to the remainder of the implement 100.

It should be appreciated that, in several embodiments, it may be desirable for the separate wing roll sections 126, 128 to remain in general contact with one another at the interface defined between the inner support members 158 of the wing roll sections 126, 128. In such embodiments, a sliding interface may be provided directly between the wing roll sections 126, 128 to accommodate relative movement therebetween. For instance, a low-friction coating or component may be provided at the interface defined between the inner support members 158 of the wing roll sections 126, 128. Specifically, in one embodiment, a low-friction plate or guard 210 (e.g., formed from a plastic or other suitable polymer material) may be coupled to the inner end of each inner support member 158 (or to one of such inner support members 158) to provide a low-friction sliding interface between the wing roll sections 126, 128 that permits relative sliding movement therebetween without binding or the like.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A rear-folding agricultural implement, comprising:
a chassis assembly;
a toolbar assembly coupled to the chassis assembly, the toolbar assembly trailing the chassis assembly in a fore-aft direction of the implement when the implement is moved in a forward travel direction, the toolbar assembly comprising:
a central toolbar section configured to support one or more row units for performing a ground-engaging operation when the implement is in a working position relative to the ground;
first and second wing roll sections pivotably coupled to the central toolbar section and configured to be positioned rearward of the central toolbar section in the fore-aft direction when the implement is in the working position, the first wing roll section being pivotably relative to the central toolbar section independently from the second wing roll section;
a first wing toolbar section pivotably coupled to the first wing roll section and extending outwardly from the first ring roll section in a lateral direction of the implement when the implement is in the working position, the first wing toolbar section being configured to support a first plurality of row units for performing the ground-engaging operation when the implement is in a working position relative to the ground; and
a second wing toolbar section pivotably coupled to the second wing roll section and extending outwardly from the second ring roll section in a lateral direction of the implement when the implement is in the working position, the second wing toolbar section being configured to support a second plurality of row units for performing the ground-engaging operation when the implement is in a working position relative to the ground.

2. The implement of claim 1, wherein the chassis assembly comprises a support chassis and a towbar extending forward of the support chassis in the fore-aft direction, the toolbar assembly being pivotably coupled to the support chassis at a forward toolbar pivot joint to allow the toolbar assembly to be pivoted relative to the support chassis about the forward toolbar pivot joint.

3. The implement of claim 2, further comprising at least one lift cylinder coupled between the chassis assembly and the toolbar assembly such that actuation of the at least one lift cylinder results in the toolbar assembly being pivoted relative to the support chassis about the forward toolbar pivot joint.

4. The implement of claim 3, wherein the chassis assembly comprises a chassis support wheel configured to support the chassis assembly relative to the ground and wherein the toolbar assembly comprises a wing support wheel configured to support the toolbar assembly relative to the ground.

5. The implement of claim 4, wherein a wheel spacing distance defined in the fore-aft direction between a rotational axis of the chassis support wheel and a rotational axis of the wing support wheel is maintained less than 30 inches as the at least one lift cylinder results is actuated to pivot the toolbar assembly relative to the support chassis.

6. The implement of claim 2, wherein the support chassis is configured to support a storage tank for storing an agricultural material.

7. The implement of claim 1, wherein the ground-engaging operation comprises a strip tillage operation.

8. The implement of claim 1, further comprising a first roll cylinder coupled between the central toolbar section and the first wing roll section and a second roll cylinder coupled between the central toolbar section and the second wing roll section, wherein actuation of the first roll cylinder results in the first wing roll section pivoting relative to the central toolbar section about a first wing roll pivot joint independent of the second wing roll section and wherein actuation of the second roll cylinder results in the second wing roll section pivoting relative to the central toolbar section about a second wing roll pivot joint independent of the first wing roll section.

9. The implement of claim 8, wherein a sliding interface is provided directly between the first and second wing roll sections.

10. The implement of claim 1, wherein at least one first fold cylinder is coupled between the first wing roll section and the first wing toolbar section, wherein actuation of the at least one first fold cylinder results in the first wing roll section folding relative to the first wing roll section about a first wing roll pivot joint.

11. The implement of claim 10, wherein at least one second fold cylinder is coupled between the second wing roll section and the second wing toolbar section, wherein actuation of the at least one first fold cylinder results in the second wing roll section folding relative to the second wing roll section about a second wing roll pivot joint.

12. The implement of claim 10, wherein the at least one first fold cylinder comprises inner and outer folder cylinders, the inner fold cylinder being coupled between the first wing roll section and a four-bar linkage supported by the first wing roll section, the second outer fold cylinder being coupled between the four-bar linkage and the first wing toolbar section.

13. The implement of claim 1, wherein at least one of the first and second wing toolbar sections has a ladder-type configuration including a forward toolbar member, an aft toolbar member, and a plurality of cross-support members extending between the forward and aft toolbar members.

14. The implement of claim 1, wherein a first rockshaft is pivotably coupled to the first wing toolbar section, the first set of row units being coupled to the first rockshaft such that actuation of the first rockshaft results in an adjustment of a position of the first set of row units relative to the first wing toolbar section.

15. The implement of claim 14, wherein actuation of the first rockshaft results in the first set of row units being shifted relative to the first wing toolbar section in a direction away from the second set of row units.

16. The implement of claim 14, wherein a second rockshaft is pivotably coupled to the second wing toolbar section, the second set of row units being coupled to the second rockshaft such that actuation of the second rockshaft results in an adjustment of a position of the second set of row units relative to the second wing toolbar section.

17. The implement of claim 16, wherein actuation of the first rockshaft results in the first set of row units being shifted in a direction away from the second set of row units and actuation of the second rockshaft results in the second set of row units being shifted in a direction away from the first set of row units to increase a distance defined between the first and second seconds of row units.
